(19) United States
(12) Patent Application Publication
(10) Pub. No.: US 2008/0266742 A1
(43) Pub. Date: Oct. 30, 2008

(54) Apparatus and method for increasing switching life of electromechanical contacts in a hybrid power switching device

(75) Inventors: Reinhold Henke, Plymouth, MN (US); Lawrence J. Glentz, Cochrane, WI (US); Keith D. Ness, Winona, MN (US)

Correspondence Address: Brinks Hofer Gilson & Lione/Ann Arbor, 524 South Main Street, Suite 200, Ann Arbor, MI, 48104, US

(73) Assignee: Watlow Electric Manufacturing Company, St. Louis, MO (US)

(21) Appl. No.: 11/799,069

(22) Filed: Apr. 30, 2007

(51) Int. Cl. H01H 47/00; H01H 47/32

(52) U.S. Cl. 361/166; 361/139; 361/189; 361/196

(57) ABSTRACT

A circuit and related methods for use in a hybrid power switching device are provided that include at least one electromechanical relay having a coil and a contact, the electromechanical relay defining a release time and a sticking time during an on-to-off transition. At least one solid state switch is electrically connected to the contact, and a timing circuit is electrically connected to the electromechanical relay and the solid state switch. The timing circuit includes a capacitor electrically connected to a control signal input and at least one resistor electrically connected to the capacitor and to the solid state switch, wherein the capacitor and the resistor are sized such that the capacitor discharges through the resistor to activate the solid state switch for a period of time that is longer than the electromechanical relay release time and sticking time.

### FIELD

The present disclosure relates to high current power switching devices and more particularly to hybrid switching devices, which include both electromechanical and solid-state relays, and methods for increasing the switching life of contacts in the electromechanical relay.

### BACKGROUND

The statements in this section merely provide background information related to the present disclosure and may not constitute prior art.

High current power switching devices often employ both electromechanical relays and solid-state switches and are thus referred to in the art as a “hybrid” power switching devices. Solid-state switches are generally employed because they do not include any moving parts, generate a relatively low amount of electrical noise during operation, are compatible with digital circuitry, and have generally greater switching life. However, solid-state switches in the form of solid-state relays produce a relatively high voltage drop, and as a result, generate a substantial amount of heat. This heat must be dissipated during operation and is often achieved through bulky and cost consuming heat sinks.

The electromechanical relay generally includes a coil and electrical contacts, wherein the contacts are actuated by current that flows through the coil. The electromechanical relay is desirable due to its low resistance, or low voltage drop across the contacts, which results in a relatively small amount of heat that must be dissipated from the power switching device during operation. However, because a physical closing and opening of the contacts is required, arcing occurs across the contacts during opening, or “break,” and during closing, or “make.” In one instance, when the electromechanical relay is being opened, arcing is generally preceded by contact sticking due to a microweld that occurs across the contact and from a spring-loaded force of the contact armature. Electromechanical relay contact sticking and contact erosion are related. The greater the erosion of the contacts, the greater the likelihood that the contacts will stick due to the eroded texture of the contact surfaces. Prior art hybrid relays account for the release time of the electromechanical relay, but do not take into account the stick time. Both arcing and sticking can cause damage to contacts through this process of erosion, which is a primary cause of electromechanical relay breakdown/failure. As such, increasing the switching life of electromechanical relay contacts remains a formidable issue in the design of hybrid power switching devices.

### SUMMARY

In one form, a circuit for use in a power switching device is provided that comprises at least one electromechanical relay having a coil and a contact, the electromechanical relay defining a release time and a sticking time during an on-to-off transition. At least one solid state switch is electrically connected to the contact and a timing circuit is electrically connected to the electromechanical relay and the solid state switch comprising. The timing circuit comprises a capacitor electrically connected to a control signal input and at least one resistor electrically connected to the capacitor and to the solid state switch, wherein the capacitor and the resistor are sized such that the capacitor discharges through the resistor to activate the solid state switch for a period of time that is longer than the electromechanical relay release time and sticking time.

In another form, a circuit for use in a power switching device is provided that comprises an input control signal circuit, a power supply circuit, and a relay control circuit. The relay control circuit comprises at least one electromechanical relay having a coil and a contact, the electromechanical relay defining a release time and a sticking time during an on-to-off transition, a diode electrically connected to the coil of the electromechanical relay, and an optoisolator electrically connected to the electromechanical relay. A power contact circuit is also provided that comprises at least one load connection, at least one solid state switch electrically connected to the electromechanical relay and to the load connection. Furthermore, a timing circuit is provided that comprises a capacitor electrically connected to a control signal input, at least one discharging resistor electrically connected to the capacitor and to the solid state switch, and a plurality of charging resistors electrically connected to the capacitor and to the electromechanical relay, wherein the plurality of charging resistors charge the capacitor during an off-to-on transition, and the capacitor and the resistor are sized such that the capacitor discharges through the resistor to activate the solid state switch for a period of time that is longer than the electromechanical relay release time and sticking time.

In yet another form, a hybrid power switching device is provided that comprises an input solid-state relay, an electromechanical relay electrically connected to the solid-state relay, the electromechanical relay defining a release time and a sticking time during an on-to-off transition. A solid state switch is electrically connected to the electromechanical relay and to a load connection, and a timing circuit comprises a capacitor electrically connected to a control signal input and at least one discharging resistor electrically connected to the capacitor and to the solid state switch. A fusing resistor is electrically connected to a terminal of the solid state switch and to the load connection, wherein the capacitor and the resistor are sized such that the capacitor discharges through the resistor to activate the solid state switch for a period of time that is longer than the electromechanical relay release time and sticking time.

Still in another form, a circuit for a power switching device is provided that comprises a first electromechanical relay comprising a coil and a contact, the first electromechanical relay defining a release time and a sticking time during an on-to-off transition, and a first triac is electrically connected to the contact of the first electromechanical relay. A second electromechanical relay comprises a coil and a contact, the second electromechanical relay defining a release time and a sticking time during an on-to-off transition, and a second triac is electrically connected to the contact of the second electromechanical relay. A third electromechanical relay comprises a coil and a contact, the third electromechanical relay defining a release time and a sticking time during an on-to-off transition, and a third triac is electrically connected to the contact of the third electromechanical relay. A timing circuit is electrically connected to the electromechanical relays and the triacs and comprises a capacitor electrically connected to a control signal input and at least one resistor electrically connected to the capacitor and to the triacs, wherein the capacitor and the resistor are sized such that the capacitor discharges through the resistor to activate the triacs for a period of time that is longer than the release times and sticking times of the electromechanical relays.

Additionally, a hybrid power switching device of the type that includes a solid-state relay and an electromechanical relay is provided, the hybrid power switching device comprising a circuit that includes a fusing resistor electrically connected to a main load current carrying means and to a load connection, the fusing resistor having a relatively low ohmic value.

According to a method of the present disclosure, increasing the switching life of electromechanical relay contacts in a hybrid power switching device can be achieved by determining a release time and a sticking time of an electromechanical relay and sizing a capacitor and a discharging resistor such that the capacitor discharges through the discharging resistor to activate a solid state switch for a period of time that is longer than the release time and sticking time of the electromechanical relay during an on-to-off transition.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a power switching device constructed in accordance with the principles of the present disclosure;

FIG. 2 is an exploded perspective view of a power switching device constructed in accordance with the principles of the present disclosure;

FIG. 3 is an electrical schematic illustrating a circuit for use in a power switching device and constructed in accordance with the principles of the present disclosure; and

FIG. 4 is a flow diagram illustrating a method of increasing the switching life of electromechanical relay contacts in accordance with the principles of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

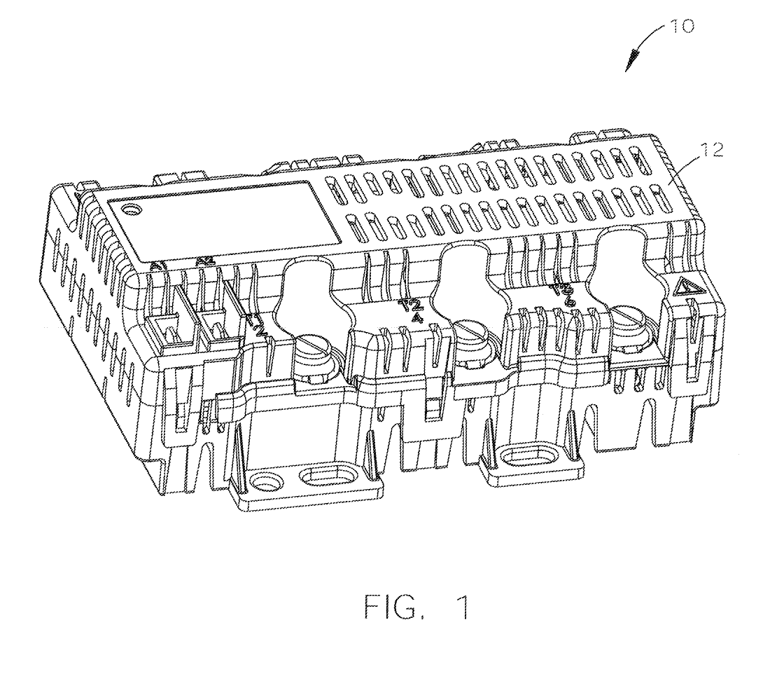

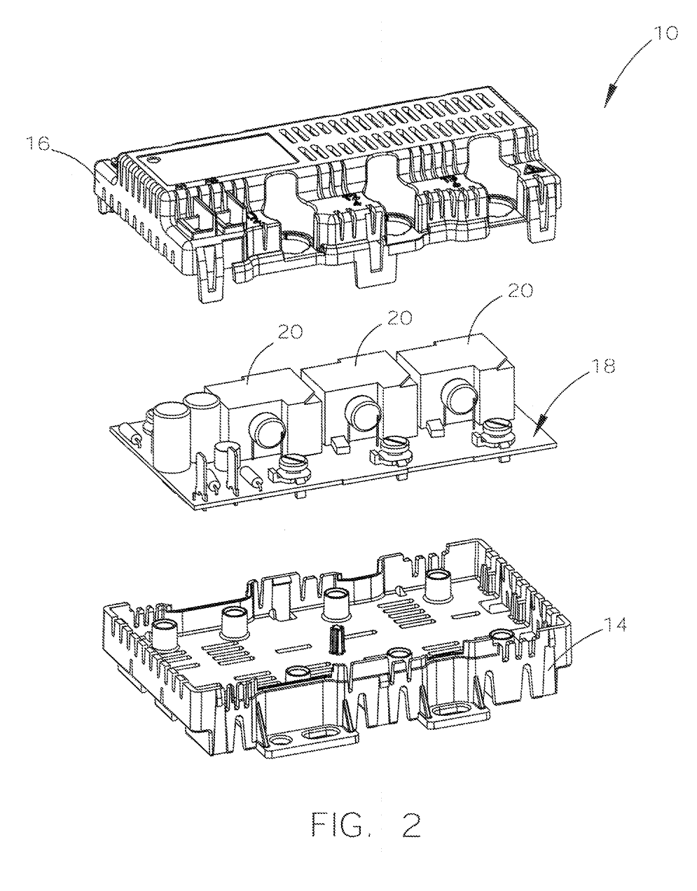

Referring to FIGS. 1 and 2, a hybrid power switching device in which circuits of the present disclosure are employed is illustrated and generally indicated by reference numeral 10. The hybrid power switching device 10 generally comprises a housing 12 that includes a base 14 and a cover 16 which are removably engageable with each other. A printed circuit board (PCB) 18 is disposed within the housing 12, and the PCB 18 includes a plurality of electrical components mounted thereon, including electromechanical relays 20 as shown. Although three (3) electromechanical relays 20 are shown, for three-phase power switching, it should be understood that one, two, or any other number of electromechanical relays 20 may be employed while remaining within the scope of the present disclosure. Also included among the plurality of electrical components on the PCB 18 are corresponding solid state switches 22 (on back side of PCB 18 and thus not shown), hence resulting in a hybrid power switching device 10. The electromechanical relays 20 and the solid state switches 22 are operated through inventive circuits and methods in accordance with the principles of the present disclosure such that the life of the electromechanical relays 20 is advantageously increased. It should be understood that these circuits and methods, as described in greater detail below, can be applied to other hybrid power switching devices, and thus the hybrid power switching device 10 as illustrated herein is merely exemplary and should not be construed as limiting the scope of the present disclosure. The hybrid power switching device 10 is described in greater detail in copending application titled “Heat Management System for a Power Switching Device,” filed concurrently herewith on Apr. 30, 2007, which is commonly assigned with the present application and the contents of which are incorporated herein by reference in their entirety.

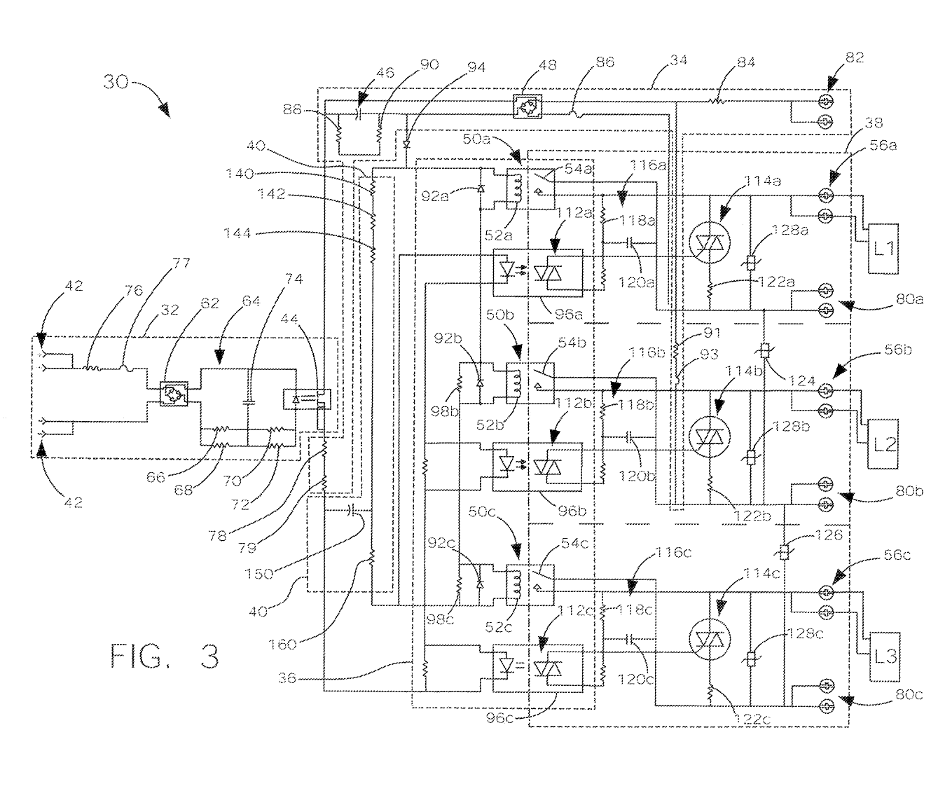

Referring now to FIG. 3, a circuit for the hybrid power switching device 10 in accordance with the principles of the present disclosure is illustrated and generally indicated by reference numeral 30. The circuit 30 generally comprises an input control signal circuit 32, a power supply circuit 34, a relay control circuit 36, a power contact circuit 38, and a timing circuit 40. Generally, a control signal is sent to the input control signal circuit 32 via input terminals 42 and a solid state relay 44 turns on and allows current to flow to the remaining circuits, namely, the power supply circuit 34, the relay control circuit 36, the power contact circuit 38, and the timing circuit 40. The power supply circuit 34 then supplies power for the relay control circuit 36 and the timing circuit 40 through a capacitor 46 and bridge rectifier 48.

As further shown, the relay control circuit 36 comprises a plurality of electromechanical relays 50a, 50b, and 50c, each including a coil 52a, 52b, and 52c, and a contact 54a, 54b, and 54c, respectively. In the exemplary circuit 30 shown, there are three (3) electromechanical relays 50 for three-phase operation, and it should be understood that one (1), two (2), or any number of electromechanical relays 50, and corresponding components as described in greater detail below, may be employed while remaining within the scope of the present disclosure. As current is provided to the relay control circuit 36 from the power supply circuit 34, the coils 52 begin to establish a magnetic field, which when strong enough, activate the contacts 54 to a closed, or “make,” position, corresponding to an off-to-on transition of power through the circuit 30. Accordingly, main current is provided to loads L1, L2, and L3, which are connected to the circuit 30 at terminals 56a, 56b, and 56c, respectively. When current from the power supply circuit 34 is cut-off during an on-to-off transition of power through the circuit 30, the magnetic fields in the coils 52 begin to collapse, which causes the contacts 54 to open, or “break,” thus disconnecting the main current path from the loads L1, L2, and L3. The circuit 30 in accordance with the teachings of the present disclosure is able to suppress arcing across the contacts 54 during the off-to-on and on-to-off transitions and to reduce sticking of the contacts 54 during the on-to-off transition as described in greater detail below. As a result, erosion of the contacts 54 is reduced and the switching life of the contacts 54 is advantageously increased. This increase in switching life of the contacts 54 will be understood with reference to each of the individual circuits, now described in greater detail.

Input Control Signal Circuit

The input control signal circuit 32 comprises control signal input terminals 42, a bridge rectifier 62 to support either AC or non-polarized DC operation, a signal filter 64, and the solid state relay 44. The solid state relay 44 provides galvanic isolation and high voltage solid state relay contact operation and in one form is an optocoupler as shown. The signal filter 64 is preferably comprised of elements 66, 68, 70, and 72, which function as current limiters and filter, and a capacitive timing element 74, which also functions as a filter element. As further shown, the input control signal circuit 32 also includes an input surge limiting resistor 76 and an input current fusing element 77.

Power Supply Circuit

The power supply circuit 34 comprises power connections 80a, 80b, and 80c and a neutral power connection 82. As previously set forth, the power supply circuit 34 also includes the capacitor 46, which functions as a ripple filter element, and bridge rectifier 48, which functions as an internal power supply to the circuit 30. The power supply circuit 34 also includes a surge limiting resistor 84 that is preferably used in single and three phase high voltage applications, a current fusing element 86, and power supply bleed resistive elements 88 and 90. The resistive elements 88 and 90 are configured to discharge the capacitor 46 to a safer voltage level within a specified amount of time after load power is removed. Additionally, current limiting resistors 78 and 79 are electrically connected to the solid state relay 44 in order to limit the amount of current that is supplied to the relays 50. As further shown, a power supply surge limiting resistor 91 and a power wire jumper 93 are also provided in one form of the present disclosure. The power wire jumper 93 is configured to support multiple population options for the hybrid power switching device 10. More specifically, depending on whether low voltage control inputs (3 to 32 Vdc or 24 Vac,) or high voltage control inputs (120 Vac to 240 Vac) are employed, the components within the input control signal circuit 32 and its related components will change.

Relay Control Circuit

The relay control circuit 36 comprises the electromechanical relays 50a, 50b, and 50c as previously set forth, along with corresponding diodes 92a, 92b, and 92c to carry collapsing field energy back through the coils 52a, 52b, and 52c for EMI (electromagnetic interference) suppression. Also included is an LED (light emitting diode) 94 that indicates when the contacts 54 are closed and current is flowing through the relay control circuit 36. As further shown, electro-optical coupling elements 96a, 96b, and 96c are electrically connected to the relays 50a, 50b, and 50c, respectively, to provide galvanic isolation. Additionally, resistive elements 98b and 98c are provided across the diodes 92b and 92c as shown when the circuit 30 is operated under single phase or dual phase. More specifically, resistive element 98b is a resistive placeholder for the coil 52b under single phase operation, and resistive element 98c is a resistive placeholder for the coil 52c under single or dual phase operation.

Power Contact Circuit

The power contact circuit 38, which includes a power contact circuit for each phase operation, comprises connections 56a and 80a for single phase, connections 56a and 80a with connections 56b and 80b for two phase, and connections 56a and 80a, 56b and 80b, and 56c and 80c for three phase. The power contact circuit 38 further comprises the contacts 54a, 54b, and 54c, and diac sections 112a, 112b, and 112c of electro-optical coupling elements 96a, 96b, and 96c, respectively, which provide firing control of solid state switches 114a, 114b, 114c. Preferably, the solid state switches 114a, 114b, and 114c are triacs as shown, however, it should be understood that other types of solid state switches such as thyristors, solid state relays, diode bridges with field effect transistors (FETs), among others, may be employed while remaining within the scope of the present disclosure. The solid state switches 114a, 114b, and 114c provide semiconductor based contact elements to carry the main load current for a period of time for arc suppression during the off-to-on transition.

As further shown, snubber circuits 116a, 116b, and 116c are provided to suppress EMI for the solid state switches 114a, 114b, and 114c. The snubber circuits 116a, 116b, and 116c comprise resistors 118a, 118b, and 118c that are electrically connected to the contacts 54 of the relays 50, along with capacitors 120a, 120b, and 120c that are electrically connected to the resistors 118a, 118b, and 118c and to terminals of the solid state switches 114a, 114b, and 114c as shown.

Additionally, fusing resistors 122a, 122b, and 122c are electrically connected to terminals of the solid state switches 114a, 114b, and 114c, respectively, and to the power connections 80a, 80b, and 80c. As such, the solid state switches 114 are protected from over-current conditions and excessive heat generation. Preferably, the fusing resistors 122 have a relatively low ohmic value of less than about one (1) ohm and in one form are about 50 milli-ohms.

As further shown, the power contact circuit 38 also includes voltage clamps 124 and 126 that limit a maximum surge voltage between single phase and two phase, and between two phase and three phase as shown. In one form, the voltage clamps 124 and 126 are Metal Oxide Varistors (MOVs). The power contact circuit 38 also includes voltage clamps 128a, 128b, and 128c, which function to protect the solid state switches 114a, 114b, and 114c and the relays 50 from voltage overstress. Similarly, the voltage clamps 128 in form are Metal Oxide Varistors (MOVs).

Timing Circuit

The timing circuit 40 generally includes charging resistors 140, 142, and 144, a capacitor 150, and a discharging resistor 160. The capacitor 150 is electrically connected to a control signal input from the input control signal circuit 32, and the discharging resistor 160 is electrically connected to the capacitor 150 and the solid state switches 114a, 114b, and 114c as shown. The charging resistors 140, 142, and 144 are electrically connected to the capacitor 150 and the electromechanical relays 50 as shown. The charging resistors 140, 142, and 144 charge the capacitor 150 during the on time of the relays 50. During the on-to-off transition, the capacitor 150 then discharges through the discharging resistor 160 to activate the solid state switches 114a, 114b, and 114c for a period of time. Advantageously, the capacitor 150 and the discharging resistor 160 are sized such that the capacitor 150 discharges to activate the solid state switches 114a, 114b, and 114c for a period of time during the on-to-off transition that is longer than the release time and the sticking time of the electromechanical relays 50.

Each individual electromechanical relay on the market has a different and variable amount of time that it takes for its contacts to release upon receiving a “break” signal and also a unique amount of time that the contacts stick after receiving the “break” signal. Additionally, over time, the amount of contact sticking progressively increases with increased operation. This total amount of time has been accommodated for by the timing circuit 40 according to the principles of the present disclosure by sizing the capacitor 150 and the discharging resistor 160 appropriately for the unique electromechanical relay. By way of example, for the circuit shown and an electromechanical relay of the J115F1 type from CIT Relay & Switch, the solid state switches 114 are activated for a period of time between about 40 ms and about 140 ms during the on-to-off transition. More specifically, in one form, the solid state switches 114 are activated for a period of time of about 85 ms during the on-to-off transition. As a result, the rate of increase of sticking of the contacts 54 (herein referred to generally as “reduced sticking”) is reduced, which reduces the erosion thereof, thereby resulting in increased life of the contacts 54 of the electromechanical relays 50.

After the capacitor 150 has discharged, the solid state switches 114 are deactivated and the circuit 30 is in a steady off state. Also, the LED 94 is deactivated immediately when the control signal is removed. Accordingly, sizing of the capacitor 150 and the discharging resistor 160 provides arc suppression and reduces the rate of increase of sticking of the contacts 54 during the on-to-off transition. As a result, the switching life of the contacts 54 of the electromechanical relays 50 is advantageously increased.

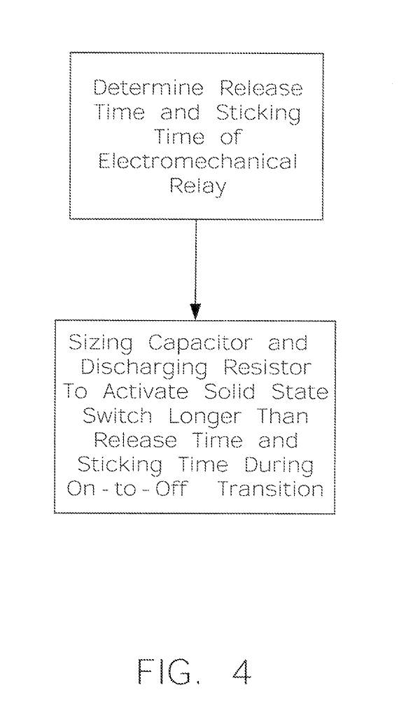

According to a method of the present disclosure as shown in FIG. 4, a release time and a sticking time of an electromechanical relay is determined, and a capacitor and discharging resistor are sized such that the capacitor discharges through the discharging resistor to activate a solid state switch for a period of time that is longer than the release time and sticking time of the electromechanical relay during an on-to-off transition. This method may be employed with the hybrid power switching device 10 as shown, whether single or multiple phase, and also to electromechanical relays alone without a hybrid configuration.

The description of the various embodiments is merely exemplary in nature and, thus, variations that do not depart from the gist of the examples and detailed description herein are intended to be within the scope of the present disclosure. Such variations are not to be regarded as a departure from the spirit and scope of the present disclosure.

1. A circuit for use in a power switching device comprising:
at least one electromechanical relay comprising a coil and a contact, the electromechanical relay defining a release time and a sticking time during an on-to-off transition;
at least one solid state switch electrically connected to the contact; and
a timing circuit electrically connected to the electromechanical relay and the solid state switch comprising:
a capacitor electrically connected to a control signal input; and
at least one resistor electrically connected to the capacitor and to the solid state switch,
wherein the capacitor and the resistor are sized such that the capacitor discharges through the resistor to activate the solid state switch for a period of time that is longer than the electromechanical relay release time and sticking time.

2. The circuit according to claim 1, wherein the solid state switch is a triac.

3. The circuit according to claim 1, wherein the capacitor and the resistor are sized such that the solid state switch is activated for a period of time between about 40 ms and about 140 ms during the on-to-off transition.

4. The circuit according to claim 1, wherein the capacitor and the resistor are sized such that the solid state switch is activated for a period of time of about 85 ms during the on-to-off transition.

5. The circuit according to claim 1 further comprising a second relay electrically connected to the at least one relay for two phase operation.

6. The circuit according to claim 5 further comprising a third relay electrically connected to the second relay for three phase operation.

7. The circuit according to claim 1 further comprising a plurality of resistors electrically connected to the capacitor and to the electromechanical relay, wherein the plurality of resistors charge the capacitor during an off-to-on transition.

8. The circuit according to claim 7, wherein the plurality of resistors comprises three resistors.

9. The circuit according to claim 1 further comprising a fusing resistor electrically connected to a terminal of the solid state switch and to a load.

10. The circuit according to claim 9, wherein the fusing resistor has a relatively low ohmic value.

11. The circuit according to claim 1 further comprising an internal power supply comprising a capacitor electrically connected to the control signal input and a bridge rectifier electrically connected to the capacitor.

12. The circuit according to claim 1 further comprising a plurality of resistors electrically connected to an input control signal circuit to limit current in the coil of the electromechanical relay.

13. The circuit according to claim 1 further comprising a snubber circuit, the snubber circuit comprising:
a resistor electrically connected to the contact of the electromechanical relay; and
a capacitor electrically connected to the resistor and to a terminal of the solid state switch.

14. A circuit for use in a power switching device comprising:
an input control signal circuit;
a power supply circuit;
a relay control circuit comprising:
at least one electromechanical relay comprising a coil and a contact, the electromechanical relay defining a release time and a sticking time during an on-to-off transition;
a diode electrically connected to the coil of the electromechanical relay; and
an optoisolator electrically connected to the electromechanical relay;
a power contact circuit comprising:
at least one load connection;
at least one solid state switch electrically connected to the electromechanical relay and to the load connection; and
a timing circuit comprising:
a capacitor electrically connected to a control signal input;
at least one discharging resistor electrically connected to the capacitor and to the solid state switch; and
a plurality of charging resistors electrically connected to the capacitor and to the electromechanical relay,
wherein the plurality of charging resistors charge the capacitor during an off-to-on transition, and the capacitor and the resistor are sized such that the capacitor discharges through the resistor to activate the solid state switch for a period of time that is longer than the electromechanical relay release time and sticking time.

15. The circuit according to claim 14, wherein the solid state switch is a triac.

16. The circuit according to claim 14 further comprising a snubber circuit, the snubber circuit comprising:
a resistor electrically connected to the contact of the electromechanical relay; and
a capacitor electrically connected to the resistor and to a terminal of the solid state switch.

17. The circuit according to claim 14, wherein the capacitor and the discharging resistor are sized such that the solid state switch is activated for a period of time between about 40 ms and about 140 ms during the on-to-off transition.

18. The circuit according to claim 17, wherein the capacitor and the resistor are sized such that the solid state switch is activated for a period of time of about 85 ms during the on-to-off transition.

19. The circuit according to claim 14 further comprising a second electromechanical relay electrically connected to the at least one electromechanical relay for two phase operation.

20. The circuit according to claim 19 further comprising a third electromechanical relay electrically connected to the second electromechanical relay for three phase operation.

21. The circuit according to claim 14 further comprising a fusing resistor electrically connected to a terminal of the solid state switch and to the load connection.

22. The circuit according to claim 21, wherein the fusing resistor has a relatively low ohmic value.

23. A hybrid power switching device comprising:
an input solid-state relay;
an electromechanical relay electrically connected to the solid-state relay, the electromechanical relay defining a release time and a sticking time during an on-to-off transition;
a solid state switch electrically connected to the electromechanical relay and to a load connection;
a timing circuit comprising:
a capacitor electrically connected to a control signal input; and
at least one discharging resistor electrically connected to the capacitor and to the solid state switch; and
a fusing resistor electrically connected to a terminal of the solid state switch and to the load connection,
wherein the capacitor and the resistor are sized such that the capacitor discharges through the resistor to activate the solid state switch for a period of time that is longer than the electromechanical relay release time and sticking time.

24. The hybrid power switching device according to claim 23, wherein the solid state switch is a triac.

25. The hybrid power switching device according to claim 23, wherein the fusing resistor has a relatively low ohmic value.

26. The hybrid power switching device according to claim 23, wherein the capacitor and the discharging resistor are sized such that the solid state switch is activated for a period of time between about 40 ms and about 140 ms during the on-to-off transition.

27. The hybrid power switching device according to claim 26, wherein the capacitor and the resistor are sized such that the solid state switch is activated for a period of time of about 85 ms during the on-to-off transition.

28. The hybrid power switching device according to claim 23 further comprising a second electromechanical relay electrically connected to the electromechanical relay for two phase operation.

29. The hybrid power switching device according to claim 23 further comprising a third electromechanical relay electrically connected to the second electromechanical relay for three phase operation.

30. A circuit for a power switching device comprising:
a first electromechanical relay comprising a coil and a contact, the first electromechanical relay defining a release time and a sticking time during an on-to-off transition;
a first triac electrically connected to the contact of the first electromechanical relay;
a second electromechanical relay comprising a coil and a contact, the second electromechanical relay defining a release time and a sticking time during an on-to-off transition;
a second triac electrically connected to the contact of the second electromechanical relay;
a third electromechanical relay comprising a coil and a contact, the third electromechanical relay defining a release time and a sticking time during an on-to-off transition;
a third triac electrically connected to the contact of the third electromechanical relay; and
a timing circuit electrically connected to the electromechanical relays and the triacs comprising:
a capacitor electrically connected to a control signal input; and
at least one resistor electrically connected to the capacitor and to the triacs,
wherein the capacitor and the resistor are sized such that the capacitor discharges through the resistor to activate the triacs for a period of time that is longer than the release times and sticking times of the electromechanical relays.

31. A hybrid power switching device of the type that includes a solid-state relay and an electromechanical relay, the hybrid power switching device comprising a circuit that includes a fusing resistor electrically connected to a main load current carrying means and to a load connection, the fusing resistor having a relatively low ohmic value.

32. A method of increasing the switching life of electromechanical relay contacts in a hybrid power switching device comprising:
determining a release time and a sticking time of an electromechanical relay; and
sizing a capacitor and a discharging resistor such that the capacitor discharges through the discharging resistor to activate a solid state switch for a period of time that is longer than the release time and sticking time of the electromechanical relay during an on-to-off transition.
